(19) United States
(12) Patent Application Publication
(10) Pub. No.: US 2005/0010494 A1
(43) Pub. Date: Jan. 13, 2005

(54) Method and apparatus for Internet e-commerce shopping guide

(75) Inventors: Tamim K. Mourad, Culver City, CA (US); Omar K. Mourad, Culver City, CA (US)

Correspondence Address: CONLEY ROSE, P.C., P. O. BOX 3267, HOUSTON, TX, 77253-3267, US

(73) Assignee: Pricegrabber.com, Culver City, CA (US)

(21) Appl. No.: 10/916,138

(22) Filed: Aug. 11, 2004

Related U.S. Application Data
(63) Continuation of application No. 09/813,690, filed on Mar. 21, 2001.
(60) Provisional application No. 60/190,789, filed on Mar. 21, 2000.

(51) Int. Cl. G06F 17/60

(52) U.S. Cl. 705/26

(57) ABSTRACT

The present invention provides online shoppers a realistic assessment of prices by comparing prices among retailers against a Reference Price. The Reference Price can be any price that provides a meaningful basis for comparison, such as the wholesale price, an average of retailer prices or the lowest historical price. Such information enables an online shopper to accurately qualify and quantify the benefits of a purchase on the Internet.

### CROSS-REFERENCE TO RELATED APPLICATION

The present application claims the benefit of U.S. Provisional Patent Application No. 60/190,789 filed Mar. 21, 2000, the disclosure of which is incorporated herein by reference.

### FIELD OF THE INVENTION

The present invention relates to an improved method and apparatus for Internet e-commerce shopping guide. More particularly, the present invention relates to an improved method of assessing retailers' product price/value.

### BACKGROUND OF THE INVENTION

On-line shopping is the display and sales of goods over a computer network. On-line shopping has exploded in popularity in recent years, as more and more people use computer networks. Generally, a potential customer can visit an on-line shopping site and can view selections or request specific items. The customer can place an order, pay for it using a credit card, and have it delivered to his or her home. The commercial importance of on-line shopping is rapidly growing as more and more people use the Internet. A Forrester Research report predicted that millions of people would purchase products and services in 2000, driving Internet retail spending to over $38 billion in the United States. The report predicted eleven million more consumers would make purchases online in 2000 and indicated that Americans are moving from surfing the Web to shopping online at a faster pace than ever before. Forrester Research also predicts that by the year 2003 online retail sales will account for $108-billion in revenues, of which $56-billion will be for “researched purchases”—information-driven, planned purchases.

On-line shopping is enjoying widespread popularity because of several attributes. Prevalent reasons for using on-line shopping include convenience, availability of vendor information, no pressure from sales people, and time savings. The greatest attribute for consumers is the convenience it offers. On-line shopping can be done at home, at work, at a library, or anywhere a person can gain access to a computer network. The second convenience factor is the ability to browse or shop at any time, day or night, in bad weather, or on weekends or holidays. Also, on-line shopping provides a much-needed service to people who have difficulty getting out to conventional stores, such as the elderly, shut-ins, or persons with small children. Further advantages are the opportunities for shoppers to compare goods and prices of competitors nearly simultaneously, allowing shoppers to perform price comparisons and choose the item with the best price or value.

However, with hundreds of millions of web pages online, one can spend a great deal of time searching for specific products and performing price comparisons on a variety of search engines. Search engines breakdown into two categories-directories and indexes. Directories are good at identifying general information. Like a card catalog in a library, they group web sites under similar categories, such as automotive. The results of a search will be a list of web sites related to a search term. But let's say what is needed is more specific information, such as a replacement soft-top for a 1982 Jeep Wrangler. In that case, web indexes are preferable, because they search all of the contents of a web site. Indexes use software programs called spiders or robots that scour the Internet, analyzing millions of web pages and newsgroup postings, indexing all of the words.

As described above, finding a desirable or low price for an item on the Internet is not an easy task. As a result, a number of companies have attempted to provide comprehensive services that comparison shop for customers. However, often times these services only provide prices from a few retailers and list prices that may not be current. If a customer does succeed in finding an item at a correct price, there is no way to measure if it is the best price available, because there is not a reference price to compare it to. Therefore, there exists a need for a guide that nondiscriminantly presents reliable retail price information as well as reference price information to facilitate e-commerce shopping.

### SUMMARY OF THE PRESENT INVENTION

The present invention provides online shoppers with a realistic assessment of prices by comparing prices among retailers against a Reference Price. The Reference Price can be any price that provides a meaningful basis for comparison, such as the wholesale price, an average of retailer prices or the lowest historical price. Such information enables an online shopper to accurately qualify and quantify the benefits of a purchase on the Internet.

The comparative-shopping search engine and spider technology of the present invention identifies and aggregates the best values for online shoppers. Furthermore, consumers are proactively connected with product retailers by informing consumers of special deals via a sign-up e-mail service.

In accordance with a preferred embodiment, a method of selling a product includes building a database of products that includes a reference price for each product and importing retail prices for each product from retailers of the products.

In accordance with an alternate preferred embodiment, a method of selling a service includes building a database of services that includes a reference price for each service and importing retail prices for each service from providers of the services.

In accordance with another preferred embodiment, a method of purchasing a product includes selecting a product from a list of products and viewing a list of retailers, where the list includes a reference price difference for each retailer in the list.

In accordance with yet another preferred embodiment, a computer coupled to a network and configured to provide a service includes building a database of products that includes a reference price for each product and importing retail prices for each product from retailers of the products.

### BRIEF DESCRIPTION OF THE DRAWINGS

A better understanding of the present invention can be obtained when the following detailed description of the preferred embodiment is considered in conjunction with the following drawings:

FIG. 1 is a block diagram showing the general overview of a preferred embodiment of the present invention;

FIG. 2 is a block diagram showing a general import overview.

FIG. 3 is a block diagram showing the retailer import overview;

FIG. 4 is a flow chart of the distributorful retailer import;

FIG. 5 is a flow chart of the distributorless import overview;

FIG. 6 is a flow chart of the distributor import;

FIG. 7 is a flow chart of the reference price; and

FIG. 8 is a flow chart of the reference difference percentage calculation.

### DETAILED DESCRIPTION OF PREFERRED EMBODIMENTS

The following detailed description describes a preferred embodiment for implementing the underlying principles of the present invention. One skilled in the art should understand, however, that the following description is meant to be illustrative of the present invention, and should not be construed as limiting the principles discussed herein. In addition, certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “includes, but is not limited to . . . ”. Also, the term “couple” or “connect” is intended to mean either an indirect or direct electrical connection. Thus, if a first device couples or connects to a second device, that connection may be through a direct electrical connection, or through an indirect electrical connection via other devices and connections.

Because the online computer purchasing and information-seeking market represents hundreds of millions of dollars annually in the United States alone, the opportunity to aggregate and present reliable comparative price, feature, and value information to a specific audience which benefits from this information, represents an exceptional market. The volume of online purchasing is expected to increase as both consumers and retailers alike continue to realize and exploit the efficiencies the Internet medium presents for online product sales and product comparison.

While one of ordinary skill in the art will appreciate that the principles of the present invention may be applied to any product or service, a preferred embodiment of the present invention applies the principles of this invention to computer and other electronic products. Pricing information is compiled from online retailers by utilizing specialized software to search the Internet, as well as from pricing information provided by retailers.

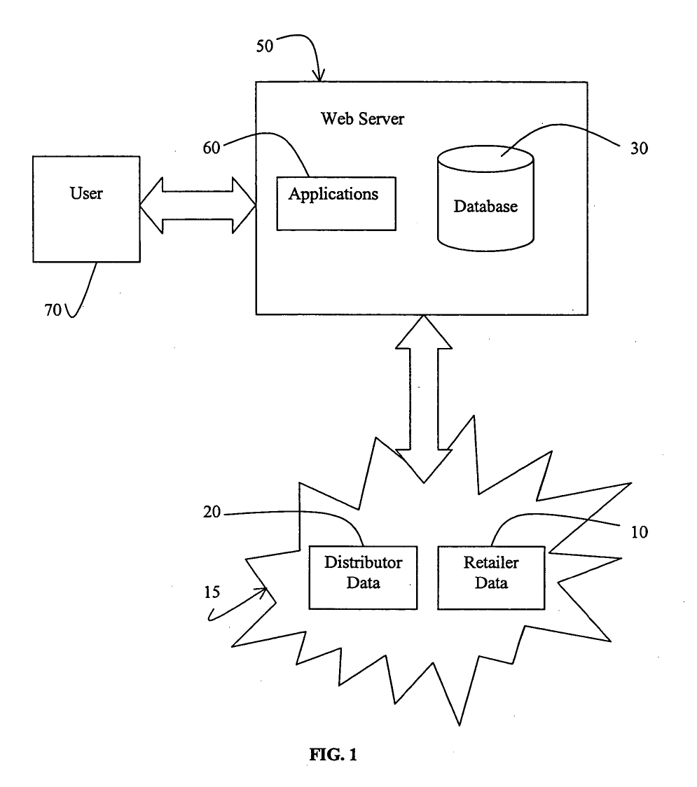

FIG. 1 shows the general overview of a preferred embodiment of the present invention. Consumers 70 start shopping by accessing applications 60 on web server 50. Applications 60 provide product, retailer, and pricing information via web site 40 before referring consumer 70 to an online retailer for purchasing the product. Applications 60 provide value added information to all online shoppers which include: shoppers who know exactly the specific product they want and are interested in obtaining the best price and availability information, as well as, shoppers who are interested in purchasing an item but need additional information such as features, ratings, warranty, and product comparisons, in order to identify a specific product.

Applications 60 request necessary information from database 30. Database 30 serves as a storage site for internal and external data 15. Internal data includes information directly entered into database 30. External data includes distributor data 20 and retailer data 10 that has been imported into database 30. Retailers supply database 30 with retail product pricing and distributors supply database 30 with wholesale product pricing.

A preferred embodiment, which is a scalable implementation of the present invention, presents users with an intuitive and informative navigation interface consisting of general subcategories, such as ‘computers’, ‘printers’ and ‘software’. Within each general subcategory there are more detailed subcategories such as ‘laptops’, ‘tower’ and ‘desktop’ computers. From this point, the subcategories include features, such as specific processors (e.g. Pentium II). Ultimately, individual products such as the ‘Toshiba Tecra 8000’ laptop computer are displayed. The process is exemplified below:
Web Site Home Page>Computers>Laptops>Pentium II>Toshiba Tecra 8000.

Using the above example, once a user has drilled down to find the Toshiba Tecra 8000, a table is presented of retailers that are offering the product for sale online, along with the price, the Reference Price (e.g. wholesale or average of retailer prices), and the number of units in stock. This table is sorted presenting the best retailer prices first.

If a user decides to buy the product, they simply click on the product hyperlink and a separate window opens to that online retailer's order screen for the selected product, through which the user may order. In a preferred embodiment, the retailer handles the transaction and order fulfillment.

Applications 60 feature an optional e-mail based ‘deal alert’ service. This alert sends editor-selected ‘deals’ to subscribers. These alerts have embedded URLs pointing back to specific products available through web site 40, creating a positive feedback loop.

Additionally, the present invention includes the ability to expand the product feature comparison service, enables user-customization, and a variety of system configurators that will allow users to configure an entire system based upon the components found at the web site.

In order for the present invention to attract customers, internet traffic is directed to server 50 by the following means:
Advertising
Lycos' Mail City (generating subscribers to the ‘deal alerts’)
Keywords on various search engines
Cobranding, also known as private labelling
Comarketing agreements such as category sponsorships

One benefit of the present invention is the ability of an online shopper to rapidly gain access to detailed product information. In addition, retailer and transaction information is compiled, processed and presented in a user-friendly and easy to understand format. The user does not need to sign on to numerous retailer sites to obtain product information, inventory verification or to compare prices. Such time consuming and often frustrating processes are eliminated by the present invention by bringing all of the pertinent information to the user. The present invention, acting as a buying guide and agent first informs the customer of all the data needed to make a purchase and then proceeds to identify the best value for the online shopper. Should the shopper decide to make a purchase, the shopper is taken directly to the corresponding retailer's Internet site to complete the transaction.

One of the problems in the state of the art is that other comparison shopping sites do not provide consumers the ability to compare prices to a “Reference Price”. The Reference Price is a price that allows the consumer to quickly quantify the value that maybe realized by making a purchase at a given price. Or more simply put, the Reference Price is the yardstick that measures how good a deal really is.

Since a Reference Price can vary from category to category, several different prices can be used to establish the Reference Price for a specific product. The Reference Price can be the wholesale price, an average of retailer prices, the lowest historical price or any other information that provides a meaningful assessment as to what retailers are charging for a specific product. Since there are millions of products offered for sale by millions of people, it would be difficult to manually make a comparison of a retailer's price to the Reference Price. As a result, applications 60 process this information to determine those products with the greatest differential between a retailer's price and the Reference Price.

Reference Price comparison can be used to locate the best deals online, offline, or anywhere else something is offered for sale. In addition to customer related products, Reference Price comparison can be used to identify commodities and raw materials offered at prices below the average price retailers are charging. Reference Price comparison can be used to identify opportunities for arbitrage.

In general, the wholesale price as the Reference Price has proved to be extremely popular and successful. An online shopper that uses web site 40 is presented not only the lowest retailer price for a product, but is also given an opportunity to compare it with its wholesale price. Shoppers browsing web site 40 and those notified about it through the email-based ‘deal alert’ service are able to purchase items at substantial savings.

Since multiple distributors can be utilized to determine the ideal wholesale price (to be used as the Reference Price), applications 60 determine a “One true wholesale price” by performing a calculation which determines the lowest wholesale price among the various distributors.

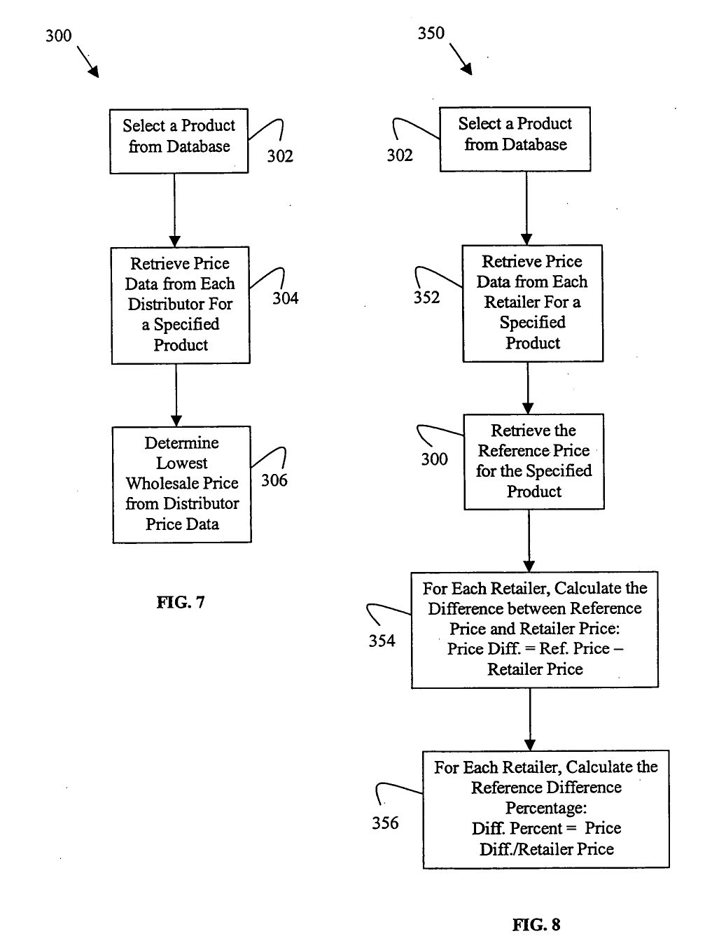

FIG. 7 shows the Reference Price as the lowest wholesale price. To determine Reference Price 300, a product is first selected 302 from database 30. Price data is retrieved 304 from each distributor for the specified product. Next, the lowest wholesale price is determined 306 from distributor price data. Reference Price 300 is the lowest distributor wholesale price.

It will be understood that price data retrieved 304 may include all prices from all retailers selling a specified product. The average retailer price may be determined 306 from the retailer price data. Reference Price 300 may be the average retailer price. Additionally, price data retrieved 304 may include the manufacturer's suggested retail price (MSRP) for a specified product, resulting in the MSRP as the Reference Price.

Once the Reference Price is determined, the reference difference percentage can be calculated. The reference difference percentage is the difference between a retailer's price for a specific product, compared to the Reference Price for that product, as a percentage. For example, a Citizen PN50 Portable Printer is offered by a retailer for $41, which is significantly lower than other online retailer prices. The wholesale price for the product is $146. This makes the $41 retailer price $105 below the wholesale price, representing a savings of 71%.

FIG. 8 provides one method of calculating the reference difference percentage. To determine reference difference percentage 350, a product is first selected 302 from database 30. Next, price data is retrieved 352 from each retailer for the specified product. Reference Price 300 is retrieved for the specific product. The difference between Reference Price 300 and retailer price is calculated 354 for each retailer. Then, reference difference percentage 350 is calculated for each retailer.

Users that have a particular product in mind can utilize applications 60 to determine which retailer offers the best price for that product. One advantage of the present invention is that web site 40 also caters to users that are interested in a product type, but do not have a specific product in mind. For example, if a user is interested in purchasing an inkjet printer but isn't sure about a specific model, web site 40 presents the user with the best deals on all inkjet printers at that particular moment. This is done by comparing product sales and Reference Prices and then presenting the best deals, allowing the user to identify and select the best value that meets their needs.

A preferred embodiment also includes a user-customization feature and the email-based ‘deal alert’ feature, which are unique to applications 60. Applications 60 allow a user to customize a shopping bot (agent) to identify specific deals for specific products. As an example, a user may task web site 40 to continually monitor the prices for a particular product or products and to alert the user through e-mail if the price of the product(s) should fall below a certain threshold, either absolute price or a differential percentage with the Reference Price. Or the user may specify to be alerted of all products within a specific category that fall below a certain user defined differential threshold compared to the Reference Price. The user-customization service may be setup to actually complete the transaction and buy the product or products on behalf of the user if requested. The email-based ‘deal alert’ service notifies users of exceptional deals on highly popular products identified by server 50's editors, via e-mail.

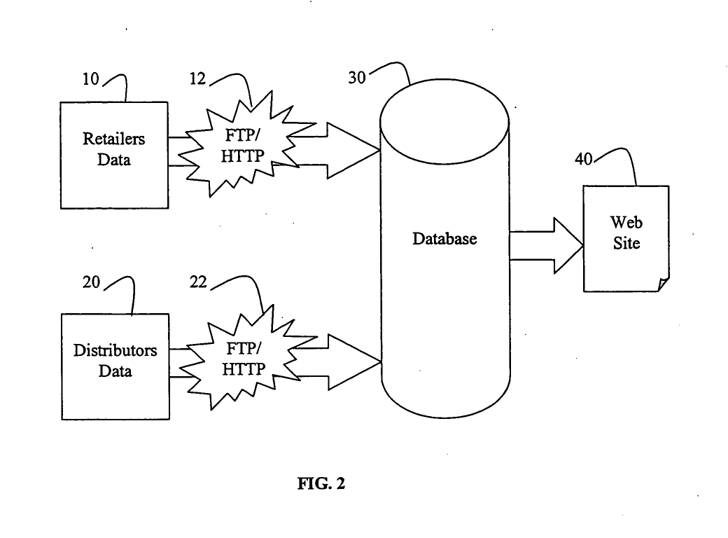

Referring now to FIG. 2, a preferred embodiment acquires data from two sources: retailers 10 and distributors 20. Retailers 10 supply database 30 with retail product pricing, descriptions and inventory information 12, and distributors 20 supply wholesale product pricing, inventory available, manufacturer name, manufacturer part number, description, distributor SKU, weight, raw category and time stamp information 22 to database 30. The foregoing data enables database 30 to derive the information necessary to stock web site 40.

Retailer data is acquired either by a direct data feed from the retailer or by analyzing the retailer's web site. The direct data feed is the most prevalent approach, whereby the retailer provides database 30 with a comma-separated-value (CSV) file containing pertinent pricing and inventory information. This data feed is typically conducted using file transfer protocol (FTP) between the retailer and server 50. The data feed is usually established at least once per day, thus ensuring that web site 40 contains timely, accurate retail product information. If a retailer is unable to supply a data feed, server 50 automatically analyze the retailer's web site to develop an equivalent data set. A customized spider application, optimized for a particular retailer, analyzes the retailer's web site using a multi-stage crawling process to ensure both depth and breadth of information retrieved. Therefore, whether a retailer supplies data directly to database 30, or a customized spider surveys the retailer's web site, web site 40 will benefit from timely, accurate pricing information.

Symmetry is maintained between the retailer and distributor application software by utilizing the same data feed versus crawl strategy. A distributor may choose to supply database 30 with a CSV data feed on a daily basis, or have a spider crawl their database to obtain the same information. The information retrieved from the distributors, however, represents much more than just “equivalent” retail information, because the distributor data set contains the wholesale costs and inventory detail for all available products, whereas the retailer data may only represent a subset of the available items. Thus, distributor data 20 is paramount in constructing unique product identifiers so that the same product is indexed across all combinations of retailers and distributors.

Using the above data feeds, server 50 provides innovative applications that establish a virtual bazaar. In instances where wholesale prices are provided as the Reference Price, end user 70 immediately knows the markup that a retailer is charging, or the loss that retailers are incurring in order to attract consumers. Even if the retailer does not supply database 30 with available inventory information, the simple cross-referencing with the distributor that services said retailer immediately alerts end user 70 to the available inventory for a particular product. Instead of offering a simple shopping service, database 30 carefully analyzes the entire product spectrum and presents the absolute best bargains available. Such information is not only valuable to consumers, but also to VARs, OEMs and retailers, who themselves utilize web site 40 as a competitive research tool.

The use of both retailer and distributor data provides the ability to provide customizable reporting and the introduction of markets that utilize the same retailer/distributor channel.

Server 50 utilizes the following software components: Perl, PHP, Linux and MySQL. Preferably, server 50 runs on Red Hat Linux 6.0, using MySQL v 3.22.23b for the database engine and Apache 1.3.4. In a preferred embodiment, all these parts run on the same server, however, as one of ordinary skill in art will appreciate, a different configuration may be utilized. The backend consists of four main parts: retailer import, retailer crawl, distributor import, database update, and miscellaneous support. These will be discussed in turn.

Retailer Import

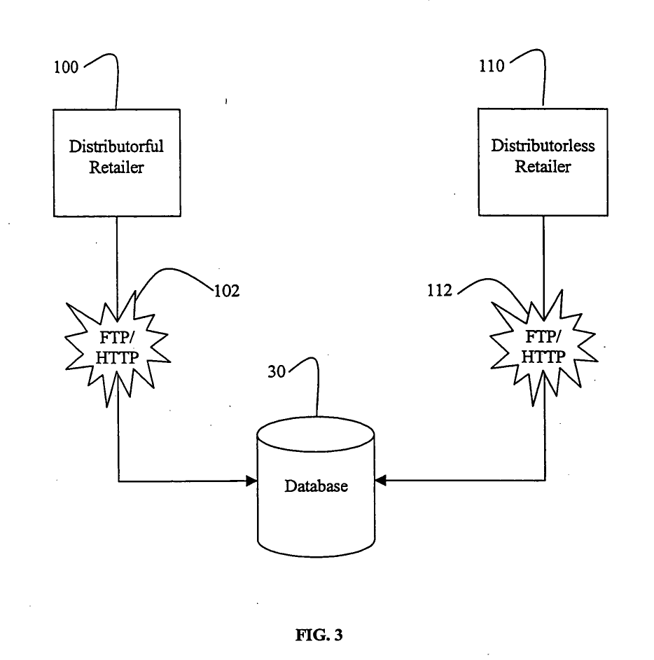

Referring now to FIG. 3, data is imported from most retailers, but not necessarily all, into database 30 via individual or group import scripts. These routines are customized Perl scripts, generally one per retailer or group of affiliated retailers. Some retailers require more than one script because they have multiple retail storefronts. The nucleus of the import code is centralized and common to all retailers. The design of the retailer import code (API) is very flexible and enables the introduction of a new retailer to the web site in a very short period of time.

Referring to FIGS. 3, 4, and 5, there are two classes of retailers: distributorful retailers 100 and distributorless retailers 110. Distributorful retailers 100 provide database 30 with manufacturer, description, manufacturer part number, distributor name, and distributor SKU information 102. Distributorless retailers 110 provide database 30 with manufacturer, description, and manufacturer part number information 112. Generally all retailers provide full price data on a daily basis.

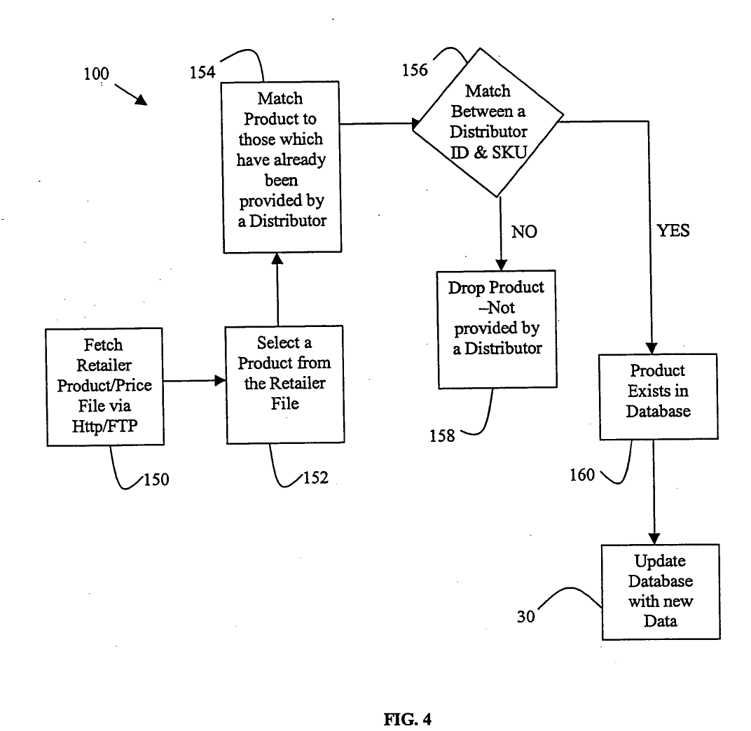

In a preferred embodiment of the present invention, only retail products corresponding to distributor products can be imported into database 30. However, as one of ordinary skill in the art will appreciate, a different setup may be implemented. Therefore, the first step in the import process is to determine whether a retailer product matches a distributor product. For distributorful retailers 100, this is a simple lookup. FIG. 4 illustrates how distributorful retailer information is imported into database 30. First, the retailer product/price file is fetched 150 via HTTP/FTP. A product is selected 152 from the retailer file. The product is matched 154 to those which have already been provided by a distributor. The product is matched 156 to a distributor ID and distributor SKU. In one embodiment, is the product does not match distributor ID and distributor SKU, the product is dropped 158 because it is not provided by a distributor. If the product does match distributor ID and distributor SKU, the product is carried 160 because it exists in database 30. Database 30 is then updated with the new data.

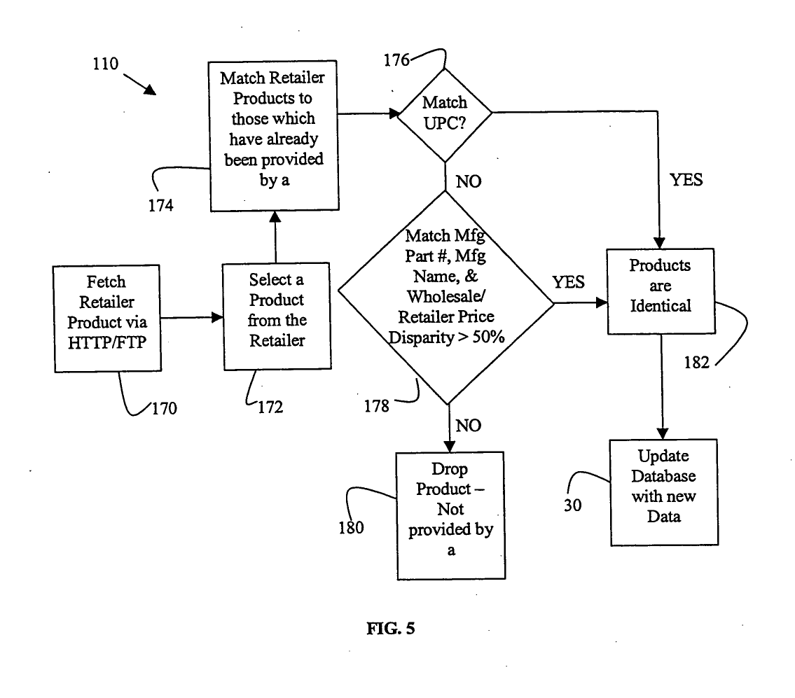

For distributorless retailers 110, this is more complicated. FIG. 5 illustrates how distributorless retail information is imported into database 30. First, the retail product file is fetched 170 via HTTP/FTP. Then a product is selected 172 from the retailer file. The product is matched 174 to products which have already been provided by a distributor. The products are then matched 176 for UPC. In one embodiment, if the product does not match UPC, it is matched 178 for manufacturer name, manufacturer part number, and wholesale/retailer price disparity >50%. The manufacturer name is matched using a fuzzy matching algorithm shared by the distributor import. If the product still does not match, it is dropped 180. Products can be rejected on the grounds of no matching manufacturer part number (for distributorless retailers), stale distributor price data, no matching distributor SKU (for distributorful retailers), missing required data, ambiguous matches, duplicate data, or ignored product. See the Database Update section regarding ignored product. Certain products and/or retailers require special processing. For example, except for memory products from memory-only retailers, accepted products are compared to the reference distributor price and inserted into the database. Memory-only products are accepted into the database with a special distributor ID and distributor reference price. However, if the product is matched 178 for manufacturer name, manufacturer part number, and wholesale/retailer price disparity >50% or matched 176 UPC, the products are determined 182 to be identical, and the product is carried. Database 30 is then updated with the new data

To prevent the appearance of artificial “deals”, stale retailer prices are removed from the site after every import or crawl, according to a sliding heuristic that prevents temporary failures from deleting a retailer's complete data

Retailer Crawl

Certain retailers may not be able to provide data feeds to database 30. To get around this, a spider crawls their site twice daily. The spider is an intelligent software robot that requests pages from the retailer's web site and retrieves the price data on them. The crawl may be impeded by uncontrollable events such as site outages, partial or total, which limit the number of product prices returned. For database import purposes, the retailer is essentially handled as a distributorless retailer, modified with part number caching to improve performance. The crawl shares the same import code as the other retailers, so that once a product and price are identified, the insertion, update, or rejection of the new data into the database is determined identically to retailers providing data files.

Distributor Import

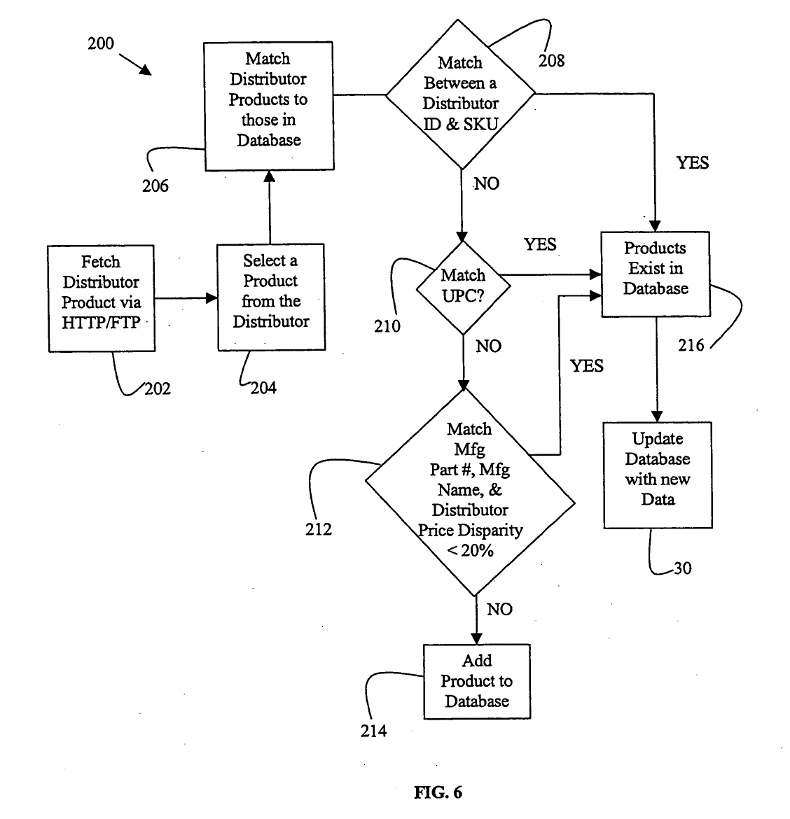

Referring now to FIGS. 2 and 6, distributor price data is imported to database 30 daily. To match identical products across distributors, uniqueness is established according to one of two criteria:
matching UPC, or
manufacturer part number, manufacturer name, and distributor price (difference of 20% or less)

FIG. 6 illustrates how distributor information 200 is imported into database 30. First, the distributor product/price file is fetched 202 via HTTP/FIP. The product is selected 204 from the distributor file. The distributor products are then matched 206 to those in database 30. The products are matched. 208 for distributor ID and distributor SKU. In one embodiment, if the product does not match distributor ID and distributor SKU, the product is matched 210 for UPC. If the product does not match UPC, the product is matched 212 for manufacturer name, manufacturer part number, and distributor price disparity <20%. If the product does not match for manufacturer name, manufacturer part number, and distributor price disparity <20%, the product is added 214 to database 30. However, if the product does match distributor ID and distributor SKU, UPC, or manufacturer name, manufacturer part number, and distributor price disparity <20%, the product exists 216 in database 30. Database 30 is then updated with new pricing, availability, etc., data

Manufacturer name equivalence is established using a fuzzy matching heuristic, which includes a synonym list for manufacturers who have changed ownership. Products thus matched become known throughout the system by their “masterid”, which is a unique numeric key for that product.

To maintain coherence of web site 40, all imported products are required to have a category. A preferred embodiment uses Ingram Micro categories for this purpose, and the categories of the other distributors are mapped onto these. Subcategories are culled from Ingram's platform/media codes, and other sources.

As with the retailers, each distributor has its own import script, but the core of the software is centralized and common to all distributors.

Database Update

Referring now to FIGS. 4, 5, and 6, the database update runs after each distributor import, retailer import, and retailer crawl. It consists of the following sections:
“One true wholesale price” calculation that determines the lowest wholesale price among the various distributors to use as the reference price for retail comparisons.
Distributor price update for retail products updates the distributor reference price for retail products older than 24 hours, to refresh the distributor price and related values of older but still valid retail prices.
Ignore processing removes products that, in the editorial opinion of server 50's staff, appear on the web site 40 with incorrect data from the retailer or distributor, making it appear that there is a “deal” when there is none; or products that for other reasons are undesirable on web site 40.
“One true retail price” calculation sets the lowest price and related data from among all the retailers, to populate the “product” page. It also ensures freshness by deleting stale products from an intermediate table holding the product+retailer-unique data
Popularity processing calculates the popularity of individual products based on click-throughs for a selectable interval preceding the processing, generally four days.
Static page generation builds static pages for web site 40.

For retailers, all but the “one true wholesale price” calculation is run; for distributors, only the wholesale price calculation and popularity processing is run.

Miscellaneous Support

There are a few other support modules, also written in Perl. One crawl obtains images of various products. Product descriptions may be similarly obtained.

There is a database integrity check script that checks relationships between the major tables of the database.

Incremental system backups are run on a nightly basis.

All system scheduled tasks are run from a cron script.

The foregoing disclosure and description of the invention are illustrative and explanatory thereof, and various changes in the size, shape, materials, components, circuit elements, wiring connections and contacts, as well as in the details of the illustrated circuitry and construction and method of operation may be made without departing from the spirit of the invention.

Numerous variations and modifications will become apparent to those skilled in the art once the above disclosure is fully appreciated. It is intended that the present invention be interpreted to embrace all such variations and modifications.

1. A method of selling a product via a web site, wherein the method comprises:
building a database of products that includes a reference price for each product;
importing retail prices for each product from retailers of the products-.;
providing a list of products to a customer;
receiving a product selection from the customer;
providing a list of retailers to the customer for the product selection, wherein the list includes a reference price difference for each retailer in the list;
receiving lists of wholesale prices from distributors of the products; and
setting the reference price for each product equal to a lowest wholesale price.

2. A computer coupled to a network and configured to provide a service, wherein the service comprises:
building a database of products that includes a wholesale price as a reference price for each product; and
importing retail prices for each product from retailers of the products.

3. The computer of claim 2, wherein the service further comprises:
providing a list of products to a customer;
receiving a product selection from the customer; and
providing a list of retailers to the customer for the product selection, wherein the list includes a reference price difference for each retailer in the list.
